(19) United States
(12) Patent Application Publication
(10) Pub. No.: US 2019/0295488 A1
(43) Pub. Date: Sep. 26, 2019

(54) DRIVER DEVICE, DRIVING METHOD FOR SAME, AND DISPLAY DEVICE

(71) Applicants: HKC Corporation Limited, Shenzehn City, Guangdong (CN); Chongqing HKC Optoelectronics Technology Co., Ltd., Chongqing (CN)

(72) Inventor: Dongsheng GUO, Chongqing (CN)

(21) Appl. No.: 16/082,890

(22) PCT Filed: Aug. 16, 2017
(86) PCT No.: PCT/CN2017/097603

§ 371 Date: Sep. 6, 2018

(30) Foreign Application Priority Data
Jun. 20, 2017 (CN) 201710468625.4

(51) Int. Cl. G09G 3/36

(52) U.S. Cl. CPC G09G 3/3677; G09G 3/3696; G09G 2320/0233; G09G 2310/08; G09G 3/3688

(57) ABSTRACT

This application provides a driver device, a driving method for same, and a display device. The driver device includes: a gate driver circuit, connected to a plurality of gate lines, wherein the gate driver circuit inputs a gate driving signal to one of the plurality of gate lines according to an order; and an enable driver circuit, providing enable signals having different time lengths to the gate driver circuit within different scanning periods, to control input time points and time lengths for inputting the gate driving signal by the gate driver circuit to the gate line.

### BACKGROUND

### Technical Field

This application relates to the field of display technologies, and in particular, to a driver device, a driving method for same, and a display device.

### Related Art

Currently, signal wires required by a gate driver circuit of a liquid crystal display panel are all wired on an array layer of the liquid crystal panel. Wires on the array layer are relatively thin, so that a corresponding impedance is relatively large.

Moreover, for a gate side of the gate driver circuit, that is, a side where gate integrated circuits (Gate ICs) are disposed, a corresponding impedance increases when a wire on array (WOA) is longer. In addition, considering the resistance voltage division principle, a gate voltage (VGH) of the last gate integrated circuit of the gate driver circuit is far less than a gate voltage of the first gate integrated circuit connected to a source driver circuit. As the gate voltage decreases, the charging efficiency of a pixel storage capacitor and a liquid crystal capacitor decreases, finally affecting the display uniformity of the liquid crystal panel.

To resolve this problem, some manufacturers use a copper process, change a material of a WOA, or increase the area of a WOA, so as to reduce a wire resistance of a gate driver circuit, and reduce a difference between gate voltages. However, for the copper process, requirements on a manufacturing environment and a manufacturing difficultly are relatively high, and it is difficult to reduce costs. It is difficult to satisfy a requirement on design of a panel having a narrow bezel when the area of the WOA is increased.

### SUMMARY

To resolve the foregoing technical problem, an objective of this application is to provide a driver device, a driving method for same, and a display device, to improve the display uniformity of a liquid crystal panel by adjusting a duty cycle of an enable signal.

The objective of this application is achieved and the technical problem of this application is resolved by using the following technical solutions. According to this application, a driver device is provided. The driver device comprises: a gate driver circuit, connected to a plurality of gate lines, wherein the gate driver circuit inputs a gate driving signal to one of the plurality of gate lines according to an order; and an enable driver circuit, providing an enable signal to the gate driver circuit within each scanning period, to control a time point for inputting the gate driving signal by the gate driver circuit, where in different scanning periods, time lengths of the enable signals provided by the enable driver circuit are different, and time points for inputting the gate driving signal by the gate driver circuit and the time lengths of the enable signals are both different.

The technical problem of this application may be further resolved by taking the following technical measures.

In an embodiment of this application, in a first scanning period, the enable driver circuit provides an enable signal having a first time length to the gate driver circuit; and in a second scanning period, the enable driver circuit provides an enable signal having a second time length to the gate driver circuit, where the first time length is greater than the second time length.

In an embodiment of this application, in the first scanning period, the gate driver circuit inputs the gate driving signal to a first gate line; and in the second scanning period, the gate driver circuit inputs the gate driving signal to a second gate line, where a wire distance between the first gate line and a source driver circuit is less than a wire distance between the second gate line and the source driver circuit.

In an embodiment of this application, the plurality of gate lines is divided into a first group of lines and a second group of lines, and the enable driver circuit provides the enable signal having the first time length to control an input time point for inputting the gate driving signal to any gate line in the first group of lines; and the enable driver circuit provides the enable signal having the second time length to control an input time point for inputting the gate driving signal to any gate line in the second group of lines, where the first time length is greater than the second time length.

In an embodiment of this application, a wire distance between the first group of lines and a source driver circuit is less than a wire distance between the second group of lines and the source driver circuit.

In an embodiment of this application, the enable driver circuit comprises a period counting unit and a signal generation unit, the signal generation unit provides a time length of the enable signal, and the period counting unit provides a quantity of the scanning periods.

In an embodiment of this application, the driver device further comprises a source driver circuit, connected to each data line, where a pixel storage capacitor and a liquid crystal capacitor are disposed at an intersection point of each data line and each gate line, and charging time lengths of pixel storage capacitors and liquid crystal capacitors connected to different gate lines are different.

In an embodiment of this application, when a wire distance of a gate line is closer to the source driver circuit, charging time lengths of the pixel storage capacitor and the liquid crystal capacitor connected to the gate line are shorter.

Another objective of this application is to provide a display device comprising: a display panel; and a driver device, comprising: a gate driver circuit, connected to a plurality of gate lines, wherein the gate driver circuit inputs a gate driving signal to one of the plurality of gate lines according to an order; and an enable driver circuit, providing an enable signal to the gate driver circuit within each scanning period, to control a time point for inputting the gate driving signal by the gate driver circuit, where in different scanning periods, time lengths of the enable signals provided by the enable driver circuit are different, and time points for inputting the gate driving signal by the gate driver circuit and the time lengths of the enable signals are both different.

In an embodiment of this application, in a first scanning period, the enable driver circuit provides an enable signal having a first time length to the gate driver circuit; and in a second scanning period, the enable driver circuit provides an enable signal having a second time length to the gate driver circuit, where the first time length is greater than the second time length.

In an embodiment of this application, in the first scanning period, the gate driver circuit inputs the gate driving signal to a first gate line; and in the second scanning period, the gate driver circuit inputs the gate driving signal to a second gate line.

In an embodiment of this application, a wire distance between the first gate line and a source driver circuit is less than a wire distance between the second gate line and the source driver circuit.

In an embodiment of this application, the plurality of gate lines is divided into a first group of lines and a second group of lines, and the enable driver circuit provides the enable signal having the first time length to control an input time point for inputting the gate driving signal to any gate line in the first group of lines; and the enable driver circuit provides the enable signal having the second time length to control an input time point for inputting the gate driving signal to any gate line in the second group of lines, where the first time length is greater than the second time length.

In an embodiment of this application, wherein a wire distance between the first group of lines and a source driver circuit is less than a wire distance between the second group of lines and the source driver circuit.

In an embodiment of this application, the enable driver circuit comprises a period counting unit and a signal generation unit, the signal generation unit provides a time length of the enable signal, and the period counting unit provides a quantity of the scanning periods.

In an embodiment of this application, the display device further comprises a source driver circuit, connected to each data line, where a pixel storage capacitor and a liquid crystal capacitor are disposed at an intersection point of each data line and each gate line, and charging time lengths of pixel storage capacitors and liquid crystal capacitors connected to different gate lines are different.

In an embodiment of this application, when a wire distance of a gate line is closer to the source driver circuit, charging time lengths of the pixel storage capacitor and the liquid crystal capacitor connected to the gate line are shorter.

Another objective of this application is to provide a driving method for a driver device, comprising: providing, by an enable driver circuit within each scanning period, an enable signal to a gate driver circuit; and inputting, by the gate driver circuit within each scanning period after the enable signal, a gate driving signal to a gate line, where in different scanning periods, time lengths of the enable signals provided by the enable driver circuit are different, and time points for inputting the gate driving signal by the gate driver circuit and the time lengths of the enable signals are both different.

In this application, requirements on the original process and product costs may be maintained without changing an existing production process significantly, a problem of uneven charging of pixel storage capacitors and liquid crystal capacitors of a display panel due to a difference between impedances of WOAs is resolved, and the display uniformity of the display panel is improved.

### BRIEF DESCRIPTION OF THE DRAWINGS

FIG. 1a is a schematic structural diagram of an exemplary driver device;

FIG. 1b is a schematic driving waveform diagram of an exemplary driver device;

FIG. 2a is a schematic architectural diagram of a driver device where an embodiment of a method according to this application is applied;

FIG. 2b is a schematic architectural diagram of a pixel circuit of a display panel where an embodiment of a method according to this application is applied;

FIG. 2c is a schematic driving waveform diagram of a driver device where an embodiment of a method according to this application is applied;

FIGS. 3a and 3b are schematic architectural diagrams of a driver device where an embodiment of a method according to this application is applied;

FIG. 4 is a schematic architectural diagram of a driver device where an embodiment of a method according to this application is applied; and

FIG. 5 is a schematic architectural diagram of a display device where an embodiment of a method according to this application is applied.

### DETAILED DESCRIPTION

The following embodiments are described with reference to the accompanying drawings, used to exemplify specific embodiments for implementation of this application.

Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, a region, and the like are enlarged. In the accompanying drawings, for understanding and ease of description, thicknesses of some layers and regions are enlarged. It should be understood that, when a component such as a layer, a film, a region, or a base is described as “above” another component, the component may be directly on the another component, or there may be a component disposed therebetween.

In addition, in this specification, unless otherwise explicitly described to have an opposite meaning, the word “include” is understood as including the component, but not excluding any other component. In addition, in this specification, “on” means being located above or below a target component, but does not inevitably mean being located on the top based on a gravity direction.

To further describe technical measures taken in this application to achieve the intended objectives and effects thereof, specific implementations, structures, features, and effects of a driver device, a driving method for same, and a display device provided according to this application are described below in detail with reference to the accompanying drawings and preferred embodiments.

A liquid crystal panel of this application may include a first substrate, a second substrate, and a liquid crystal layer formed between the two substrates. For example, the first substrate and the second substrate may be active array switch (Thin Film Transistor, TFT) substrates or color filter (CF) substrates. However, the first substrate and the second substrate are not limited thereto, and in some embodiments, an active array switch and a CF in this application may be formed on a same substrate.

In some embodiments, the liquid crystal panel in this application may be a curved display panel.

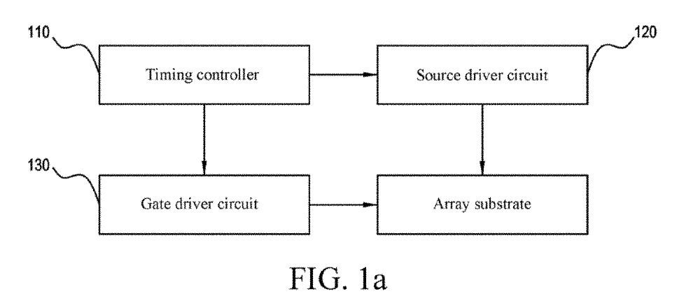

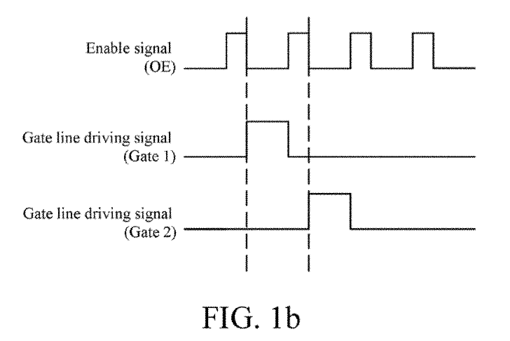

FIG. 1a is a schematic structural diagram of an exemplary driver device, and FIG. 1b is a schematic driving waveform diagram of the exemplary driver device. As shown in FIG. 1a, a display driver circuit includes: a timing controller 110, a source driver circuit 120, and a gate driver circuit 130. The timing controller 110 generally includes the following signals: a frame start signal (STV), a gate line clock signal (CPV), an output enable signal (OE), a data read and output signal (TP), a pixel polarity control signal (POL), and a data enable signal (DE). The signals STV, CPV, and OE jointly control and drive gate lines of an array substrate 140 of a display device. A rising edge of the CPV signal triggers and drives the gate lines, and triggers driving gate line driving signals of the gate lines according to an order by using a shift register. The OE signal is used to separate gate line driving signals in neighboring rows, to avoid crosstalk. The gate driver circuit 130 triggers the gate line driving signal according to the gate line clock signal, separates gate line driving signals in neighboring rows according to the output enable signal, and then outputs the separated gate line driving signals to gate lines.

As shown in FIG. 1b, at a rising edge of the gate line clock signal, a corresponding gate line driving signal is triggered to a high level. At a rising edge of the OE, a corresponding gate line driving signal (Gate 1) is pulled down to a low level, and the gate line driving signal (Gate 1) is switched off. Within a next scanning period, at a rising edge of the OE, a corresponding gate line driving signal (Gate 2) is pulled down to a low level, and the gate line driving signal (Gate 2) is switched off. It is learned that, in a high level region of the OE, gate line driving signals in neighboring rows are at low levels and are shielded, and intervals are formed between a plurality of gate line driving signals. In the interval region, a corresponding gate is forcibly closed, to avoid crosstalk when a neighboring gate is driven.

The gate driver circuit 130 includes a plurality of gate integrated circuits. When a gate integrated circuit is farther away from the source driver circuit 120, a wire required by the gate integrated circuit is longer, a relative wire impedance is higher, and an obtained gate voltage (VGH) is relatively low.

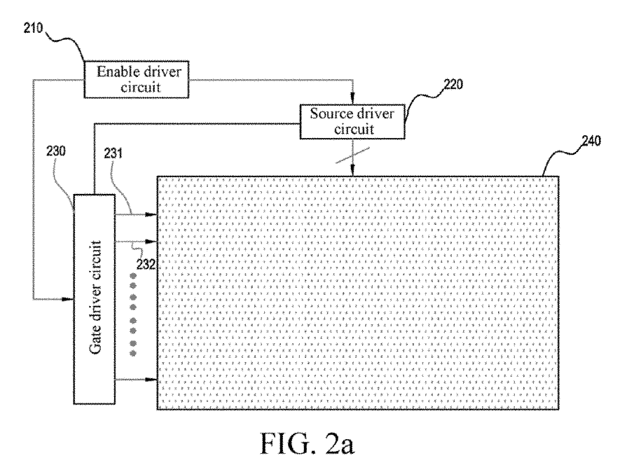

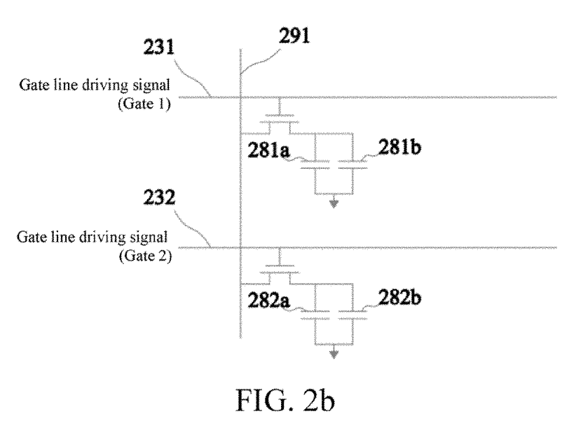

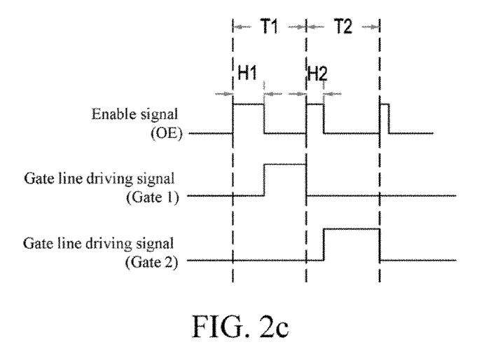

FIG. 2a is a schematic architectural diagram of a driver device of a display panel where an embodiment of a method according to this application is applied; FIG. 2b is a schematic architectural diagram of a pixel circuit of a display panel where an embodiment of a method according to this application is applied; and FIG. 2c is a schematic driving waveform diagram of a driver device where an embodiment of a method according to this application is applied. Referring to FIG. 2a, in an embodiment of this application, the driver device includes: a gate driver circuit 230, connected to a plurality of gate lines, wherein the gate driver circuit 230 inputs a gate driving signal to one of the plurality of gate lines according to an order; and an enable driver circuit 210, providing an enable signal (OE) to the gate driver circuit 230 within each scanning period, to control a time point for inputting the gate driving signal by the gate driver circuit 230. In different scanning periods, time lengths of the enable signals (OE) provided by the enable driver circuit 210 are different, and time points for inputting the gate driving signal by the gate driver circuit 230 and the time lengths of the enable signals are both different.

In some embodiments, the schematic architectural diagram of the pixel circuit is shown in FIG. 2b, and the schematic waveform diagram of the driver device is shown in FIG. 2c. Understanding is facilitated with reference to FIG. 2a. As shown in FIG. 2a, a wire distance between a first gate line 231 connected to the gate driver circuit 230 and a source driver circuit 220 is less than a wire distance between a second gate line 232 and the source driver circuit 220. That is, relative to the second gate line 232, the entire first gate line 231 is closer to the source driver circuit 220.

In some embodiments, on an array substrate 240, a pixel storage capacitor and a liquid crystal capacitor are disposed at an intersection point of each data line and each gate line, and charging time lengths of pixel storage capacitors and liquid crystal capacitors connected to different gate lines are different.

In some embodiments, when a wire distance of a gate line is closer to the source driver circuit, charging time lengths of the pixel storage capacitor and the liquid crystal capacitor connected to the gate line are shorter.

As shown in FIG. 2b and FIG. 2c, within a first scanning period (T1), the enable driver circuit 210 provides an enable signal (OE) having a first time length (H1) to the gate driver circuit 230. After the enable signal (OE) drops, the gate driver circuit 230 inputs a gate driving signal (Gate 1) to the first gate line 231. Within a second scanning period (T2), the enable driver circuit 210 provides an enable signal (OE) having a second time length (H2) to the gate driver circuit 230. After the enable signal (OE) drops, the gate driver circuit 230 inputs a gate driving signal (Gate 2) to the second gate line 232. The first time length (H1) is greater than the second time length (H2). In this case, for the scanning periods having a same time length, a time point for inputting the gate line driving signal (Gate 1) to the first gate line 231 is later than a time point for inputting the gate line driving signal (Gate 2) to the second gate line 232. A time length of the gate line driving signal (Gate 1) is also less than a time length of the gate line driving signal (Gate 2).

Therefore, charging time lengths of a pixel storage capacitor 281a and a liquid crystal capacitor 281b connected between a data line 291 and the first gate line 231 are different from charging time lengths of a pixel storage capacitor 282a and a liquid crystal capacitor 282b connected between a data line 291 and the second gate line 232. Moreover, the charging time lengths of the pixel storage capacitor 282a and the liquid crystal capacitor 282b connected to the second gate line 232 is relatively short.

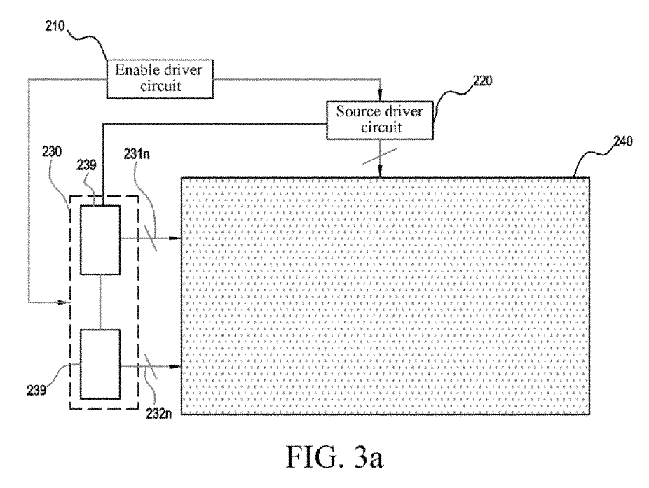

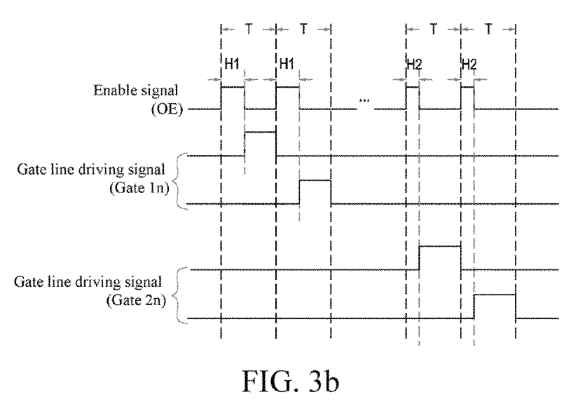

FIG. 3a is a schematic architectural diagram of a driver device of a display panel where an embodiment of a method according to this application is applied. Referring to FIG. 3a, a gate driver circuit includes a plurality of gate integrated circuits (Gate ICs) 239, and each gate integrated circuit 239 is connected to one group of gate lines. In this case, two gate integrated circuits 239 are used to give an example temporarily, and each gate integrated circuit 239 is connected to a first group of lines 231n and a second group of lines 232n.

In some embodiments, a schematic waveform diagram of the driver device is shown in FIG. 3b. Understanding is facilitated with reference to FIG. 3a. As shown in FIG. 3a, a wire distance between the first group of lines 231n connected to the gate driver circuit 230 and a source driver circuit 220 is less than a wire distance between the second group of lines 232n and the source driver circuit 220. That is, relative to the second group of lines 232n, the entire first group of lines 231n is closer to the source driver circuit 220. As shown in FIG. 3b, an enable driver circuit 210 provides an enable signal (OE) having a first time length (H1), to control an input time point for inputting a gate driving signal (Gate 1) to any gate line in the first group of lines 231n. The enable driver circuit 210 provides an enable signal (OE) having a second time length (H2), to control an input time point for inputting a gate driving signal (Gate 2) to any gate line in the second group of lines 232n. The first time length (H1) is greater than the second time length (H2). In this case, for scanning periods having a same time length, an input time point for inputting the gate line driving signal (Gate 1) to any gate line in the first group of lines 231n is later than a time point for inputting the gate line driving signal (Gate 2) to any gate line in the second group of lines 232n. A time length of the gate line driving signal (Gate 1) is also less than a time length of the gate line driving signal (Gate 2).

Therefore, charging time lengths of a pixel storage capacitor and a liquid crystal capacitor connected between a data line and the first group of lines 231n are different from charging time lengths of a pixel storage capacitor and a liquid crystal capacitor connected between a data line and the second group of lines 232n. Moreover, the charging time lengths of the pixel storage capacitor and the liquid crystal capacitor connected to the second group of lines 232n is relatively short.

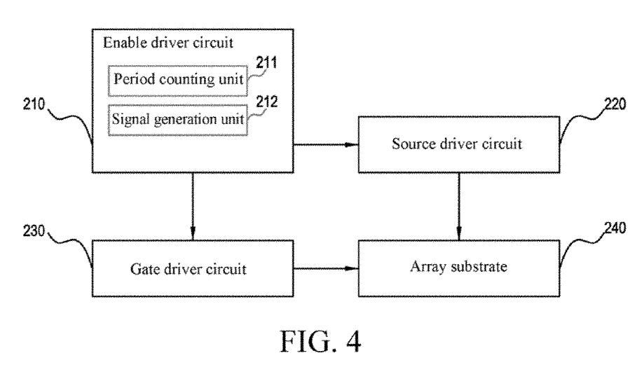

FIG. 4 is a schematic architectural diagram of a driver device of a display panel where an embodiment of a method according to this application is applied. Referring to FIG. 4, an enable driver circuit 210 includes a period counting unit 211 and a signal generation unit 212.

The signal generation unit 212 provides a time length of an enable signal OE, and the period counting unit 211 provides a quantity of scanning periods. In principle, with reference to the above description, for gate lines correspond to a scanning period, if a wire distance of a gate line is closer to a source driver circuit 220, an enable signal OE for controlling the gate line has a longer time length.

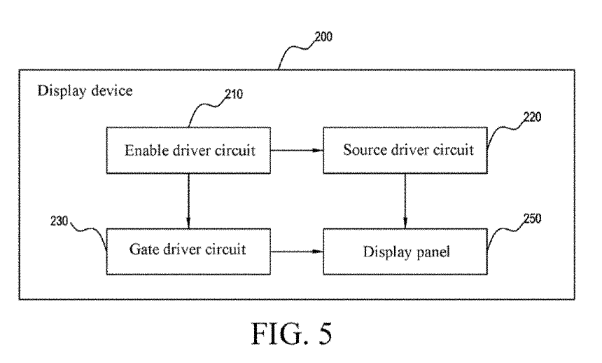

FIG. 5 is a schematic architectural diagram of a display device where an embodiment of a method according to this application is applied. In an embodiment of this application, a display device 200 in this application includes a display panel 250, and further includes any driver circuit described in the foregoing embodiments. The display panel 250 may be an active switch array substrate, that is, the foregoing array substrate 240.

In an embodiment of this application, a driving method for a driver device in this application includes: providing, by an enable driver circuit 210 within each scanning period, an enable signal OE to a gate driver circuit 230; and inputting, by the gate driver circuit 230 within each scanning period after the enable signal OE, a gate driving signal to a gate line. In different scanning periods, time lengths of the enable signals provided by the enable driver circuit 210 are different, and time points for inputting the gate driving signal by the gate driver circuit 230 and the time lengths of the enable signals OE are both different.

In this application, requirements on the original process and product costs may be maintained without changing an existing production process significantly. A duty cycle of an enable signal is adjusted according to a distance between an output channel of a gate driver circuit and a source driver circuit, so that the final charging effect of all pixel storage capacitors and liquid crystal capacitors of a panel reaches a balance value. A problem of uneven charging of pixel storage capacitors and liquid crystal capacitors of the display panel due to a factor such as a difference between impedances of WOAs is resolved, thereby improving the display uniformity of the display panel. Because the production process does not need to be adjusted, there is no special process requirement and difficulty. Therefore, costs are not increased, so as to be very competitive in the market. Moreover, because the area of WOAs does not need to be increased, this application is applicable to design of various display panels currently, is certainly also applicable to design of a panel having a narrow bezel, and conforms to market and technology trends.

The wordings such as “in some embodiments” and “in various embodiments” are repeatedly used. The wordings usually refer to different embodiments, but they may also refer to a same embodiment. The words, such as “comprise”, “have”, and “include”, are synonyms, unless other meanings are indicated in the context thereof.

Descriptions above are merely embodiments of this application, and are not intended to limit this application. Although this application has been disclosed above in forms of preferred embodiments, the embodiments are not intended to limit this application. A person skilled in the art can make some equivalent variations, alterations or modifications to the above disclosed technical content without departing from the scope of the technical solutions of this application to obtain equivalent embodiments. Any simple alteration, equivalent change or modification made to the foregoing embodiments according to the technical essence of this application without departing from the content of the technical solutions of this application shall fall within the scope of the technical solutions of this application.

What is claimed is:

1. A driver device, comprising:
a gate driver circuit, connected to a plurality of gate lines, wherein the gate driver circuit inputs a gate driving signal to one of the plurality of gate lines according to an order; and
an enable driver circuit, providing an enable signal to the gate driver circuit within each scanning period, to control a time point for inputting the gate driving signal by the gate driver circuit, wherein
in different scanning periods, time lengths of the enable signals provided by the enable driver circuit are different, and time points for inputting the gate driving signal by the gate driver circuit and the time lengths of the enable signals are both different.

2. The driver device according to claim 1, wherein in a first scanning period, the enable driver circuit provides an enable signal having a first time length to the gate driver circuit; and in a second scanning period, the enable driver circuit provides an enable signal having a second time length to the gate driver circuit.

3. The driver device according to claim 2, wherein the first time length is greater than the second time length.

4. The driver device according to claim 2, wherein in the first scanning period, the gate driver circuit inputs the gate driving signal to a first gate line; and in the second scanning period, the gate driver circuit inputs the gate driving signal to a second gate line.

5. The driver device according to claim 4, wherein a wire distance between the first gate line and a source driver circuit is less than a wire distance between the second gate line and the source driver circuit.

6. The driver device according to claim 2, wherein the plurality of gate lines is divided into a first group of lines and a second group of lines, and the enable driver circuit provides the enable signal having the first time length to control an input time point for inputting the gate driving signal to any gate line in the first group of lines; and the enable driver circuit provides the enable signal having the second time length to control an input time point for inputting the gate driving signal to any gate line in the second group of lines, wherein the first time length is greater than the second time length.

7. The driver device according to claim 6, wherein a wire distance between the first group of lines and a source driver circuit is less than a wire distance between the second group of lines and the source driver circuit.

8. The driver device according to claim 1, wherein the enable driver circuit comprises a period counting unit and a signal generation unit, the signal generation unit provides a time length of the enable signal, and the period counting unit provides a quantity of the scanning periods.

9. The driver device according to claim 1, further comprising a source driver circuit, connected to each data line, wherein a pixel storage capacitor and a liquid crystal capacitor are disposed at an intersection point of each data line and each gate line, and charging time lengths of pixel storage capacitors and liquid crystal capacitors connected to different gate lines are different.

10. The driver device according to claim 9, wherein when a wire distance of a gate line is closer to the source driver circuit, charging time lengths of the pixel storage capacitor and the liquid crystal capacitor connected to the gate line are shorter.

11. A display device, comprising:
a display panel; and
a driver device, comprising:
a gate driver circuit, connected to a plurality of gate lines, wherein the gate driver circuit inputs a gate driving signal to one of the plurality of gate lines according to an order; and
an enable driver circuit, providing an enable signal to the gate driver circuit within each scanning period, to control a time point for inputting the gate driving signal by the gate driver circuit, wherein
in different scanning periods, time lengths of the enable signals provided by the enable driver circuit are different, and time points for inputting the gate driving signal by the gate driver circuit and the time lengths of the enable signals are both different.

12. The display device according to claim 11, wherein in a first scanning period, the enable driver circuit provides an enable signal having a first time length to the gate driver circuit; and in a second scanning period, the enable driver circuit provides an enable signal having a second time length to the gate driver circuit, wherein the first time length is greater than the second time length.

13. The display device according to claim 12, wherein in the first scanning period, the gate driver circuit inputs the gate driving signal to a first gate line; and in the second scanning period, the gate driver circuit inputs the gate driving signal to a second gate line.

14. The display device according to claim 13, wherein a wire distance between the first gate line and a source driver circuit is less than a wire distance between the second gate line and the source driver circuit.

15. The display device according to claim 12, wherein the plurality of gate lines is divided into a first group of lines and a second group of lines, and the enable driver circuit provides the enable signal having the first time length to control an input time point for inputting the gate driving signal to any gate line in the first group of lines; and the enable driver circuit provides the enable signal having the second time length to control an input time point for inputting the gate driving signal to any gate line in the second group of lines, wherein the first time length is greater than the second time length.

16. The display device according to claim 15, wherein a wire distance between the first group of lines and a source driver circuit is less than a wire distance between the second group of lines and the source driver circuit.

17. The display device according to claim 11, wherein the enable driver circuit comprises a period counting unit and a signal generation unit, the signal generation unit provides a time length of the enable signal, and the period counting unit provides a quantity of the scanning periods.

18. The display device according to claim 11, further comprising a source driver circuit, connected to each data line, wherein a pixel storage capacitor and a liquid crystal capacitor are disposed at an intersection point of each data line and each gate line, and charging time lengths of pixel storage capacitors and liquid crystal capacitors connected to different gate lines are different.

19. The display device according to claim 18, wherein when a wire distance of a gate line is closer to the source driver circuit, charging time lengths of the pixel storage capacitor and the liquid crystal capacitor connected to the gate line are shorter.

20. A driving method for a driver device, comprising:
providing, by an enable driver circuit within each scanning period, an enable signal to a gate driver circuit; and
inputting, by the gate driver circuit within each scanning period after the enable signal, a gate driving signal to a gate line, wherein
in different scanning periods, time lengths of the enable signals provided by the enable driver circuit are different, and time points for inputting the gate driving signal by the gate driver circuit and the time lengths of the enable signals are both different.
